(19) United States
(12) Patent Application Publication
(10) Pub. No.: US 2019/0216249 A1
(43) Pub. Date: Jul. 18, 2019

(54) delaySAJDA

(71) Applicant: Jawed I. Aikal, Kendall Park, NJ (US)

(72) Inventor: Jawed I. Aikal, Kendall Park, NJ (US)

(21) Appl. No.: 16/238,505

(22) Filed: Jan. 2, 2019

Related U.S. Application Data
(60) Provisional application No. 62/617,212, filed on Jan. 13, 2018.

(51) Int. Cl. A47G 33/00; G06Q 10/10; G06F 17/11; G06F 3/0484; G06F 3/0482

(52) U.S. Cl. CPC A47G 33/008; G06Q 10/1093; G06F 3/0482; G06F 3/04845; G06F 17/11

(57) ABSTRACT

There are three specific times in a day, around sunrise, noon and sunset, for a total of 26 minutes, when prostration (sajda in Arabic) is forbidden, according to the religion of Islam.

This particular invention is titled, delaySAJDA, and is comprised of astronomical and mathematical formulae to derive forbidden times for sajda—the Arabic word for prostration—in the religion of Islam, three times a day, specifically during sunrise, solar noon and sunset.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The instructions for forbidden times for prostration were given over 1,400 years ago, in non-scientific terms known at that time. It reads, “The forbidden times are when the sun rises up until it is above the horizon by the length of a spear, when the sun is at its zenith and when the bottom of the sun's disc touches the horizon until it sets.”

### BRIEF SUMMARY OF THE INVENTION

By determining sunrise and sunset times for any administrative or GPS location, coupled with estimating the movement of earth relative to sun, and using the constant of 1 degree equaling 4 minutes, the three forbidden time periods are calculated.

### BRIEF DESCRIPTION OF THE SEVERAL VIEWS OF THE DRAWING

FIG. 1. The three daily forbidden times for prostration are represented by red segments. The line of sight is presumed to be at the horizon, represented by horizontal dotted line.

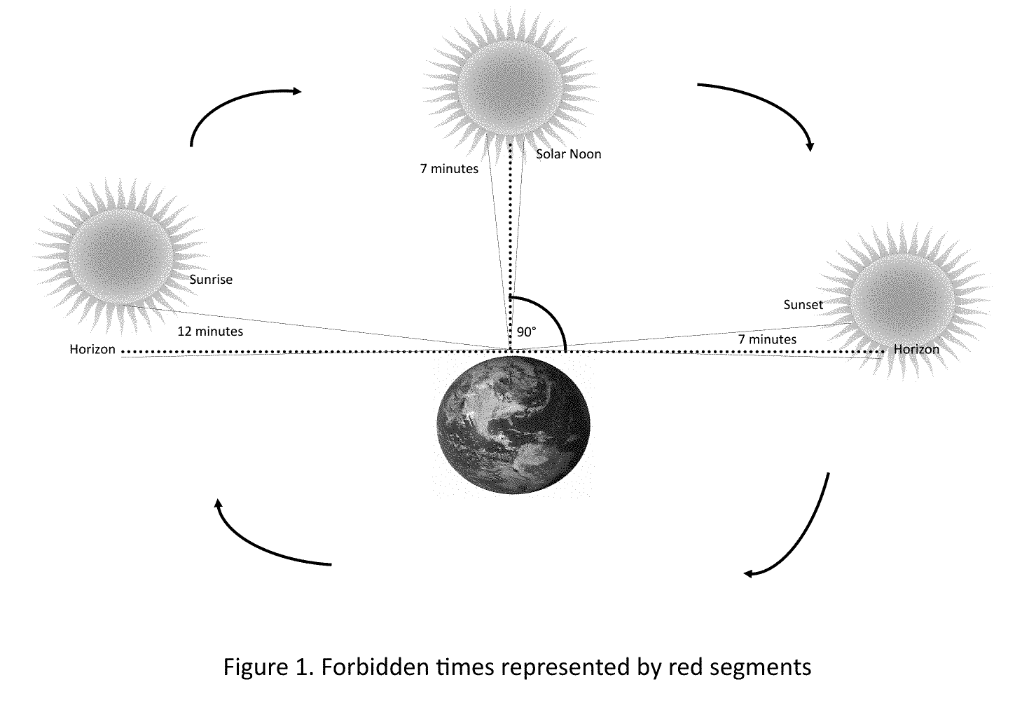

FIG. 2. The three cyclic phases—green, yellow and red—of the mobile app, delaySAJDA, representing “OK to Pray”, “Warning—forbidden time closely approaching within 5 minutes”, and “Forbidden to pray” respectively.

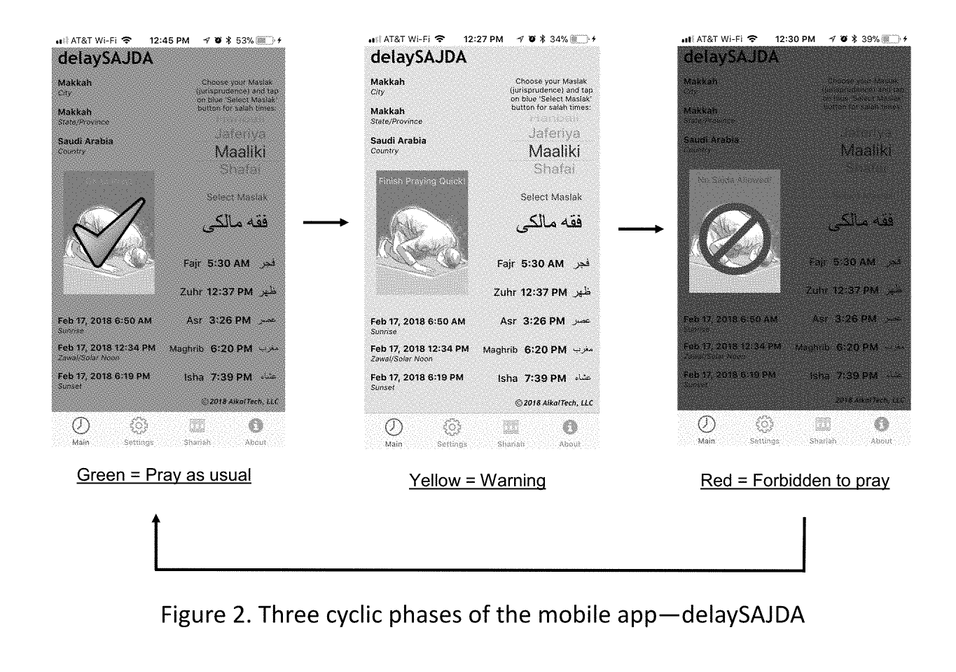

### DETAILED DESCRIPTION OF THE INVENTION

By determining how many minutes it takes for the sun to be above the horizon by the length of a spear at sunrise, how many minutes it takes for the sun to cross over the zenith during Noon, and how many minutes it takes for the sun to set once its disc touches the horizon at sunset, we can bring specificity to forbidden time periods. Add sunrise and sunset times for a specific location to this equation, and we can calculate forbidden times for any city or global location.

1. The three forbidden prostration times during the day, according to the religion of Islam, around Sunrise, Noon and Sunset, amount to approximately 26 minutes. Specifically,
(Sunrise−1 minute) through (Sunrise+10 minutes)=12 minutes,
(Noon−4 minutes) through (Noon+2 minutes)=7 minutes, and
(Sunset−5 minutes) through (Sunset+1 minute)=7 minutes.
(a) Forbidden times calculated programmatically for a specific administrative or GPS location and displayed color-coded on a mobile app—delaySAJDA—by painting the screen red; yellow as a warning five minutes in advance of forbidden times, and remaining green otherwise.
